(19) United States
(12) Patent Application Publication
(10) Pub. No.: US 2005/0000881 A1
(43) Pub. Date: Jan. 6, 2005

(54) Plate filtration module

(76) Inventor: Ulrich Bruss, Nottuln (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/491,561

(22) PCT Filed: Oct. 19, 2002
(86) PCT No.: PCT/DE02/03956

(30) Foreign Application Priority Data
Oct. 24, 2001 (DE) 101 51 833.1

(51) Int. Cl. B01D 63/00

(52) U.S. Cl. 210/321.61; 210/321.79; 210/321.88

(57) ABSTRACT

The invention relates to a filtration module for purifying waste water. Said module comprises a plurality of filter membrane pockets having at least one opening (21) for draining the inner region of the same. Said pockets are vertically arranged in a rigid supporting element (11, 12) in a parallel manner, preferably at the same distance from each other, in such a way that the gaps between adjacent filter membrane pockets can be intensively crossed by a liquid. According to the invention, the filtration module is characterised in that the filter membrane pockets are essentially plane and flexible and are fixed to the supporting element on opposite sides, said supporting element comprising at least one evacuation line (20) for evacuating the liquid which is sucked out via the filter membrane pocket openings. Furthermore, the filter membrane pockets have a flexible, liquid-permeable core (16) and a plurality of flexible, liquid-permeable core elements.

The invention relates to a filtration module for the cleaning of waste water with a multiplicity of filter membrane pockets each having at least one opening for the dewatering of its internal space and which are so arranged that the filter membrane pockets are vertical, mutually parallel and spaced apart with preferably a given distance from one another in a rigid holder and so arranged that the intervening spaces between neighboring filter membrane pockets can be intensively flushed with a liquid.

Presently available filter systems for waste water cleaning are comprised of a filter unit with a box-shaped housing which is open upwardly and downwardly and in which the multiplicity of membrane cassettes are arranged which vertically and parallel to one another are spaced from neighboring membrane cassettes. The intervening spaces between the individual membrane cassettes form passages which are traversable by a fluid. The individual membrane cassettes have a flat filter plate whose surface is covered with a filtration membrane. Below this box with the membrane cassettes a housing is arranged which includes a device providing air feed through which an upward flow is produced by means of which the liquid flows along the membrane cassettes. Each of the membrane cassettes has withdrawal ducts which open into a liquid gathering type in which a suction pump is disposed by means of filtered liquid can be drawn off. In EP 0 662 341 B1 a drawback of this filter system is noted whereby the filter plate which is used and is composed of solid material has the consequence that only a thin layer is formed during passage of the traversing liquid between the filtration membrane and the filter plate surface so that higher throughflow resistance is achieved. Since the transmembrane pressure is not uniform over the entire surface of the filtration membrane of the membrane cassette, there is a pressure concentration in the vicinity of the tray with which the liquid gathering duct is connected so that the filtration in pockets of the box gives rise to an increase in fouling. To alleviate this problem, a module with filtration membranes is proposed in which the membrane support plate of each membrane cassette is configured to be hollow whereby the support plate is assembled from a rigid frame structure which carries the solid core pieces and has intervening recesses. In this membrane support plate an outlet opening is arranged through which the filtered liquid can be withdrawn.

Following a further proposal according to EP 0 662 341 B1, the membrane cassette encompasses a pocket-shaped filtration membrane which covers the outer surface of a membrane support plate which is hollow and comprised of a number of bar-shaped stiff membrane support elements arranged parallel to one another. To one end of this membrane support element, a coupling frame element is associated so that basically in this filter membrane pocket a rigid frame-shaped body is also arranged. Similar solutions with rigid frame-like filtration cassettes are also described in EP 0 602 560 B1 or EP 0 510 328 B1. Whether a solid body plate or a frame profile is used, there remains, however, in both cases the disadvantage that locally different flow resistances will arise which limits uniform flow distribution and thus can block the cleaning effect. This disadvantageous effect is further amplified with increasing periods of use of the filter system since particles can deposit in the edge regions of the cassettes.

Another undesirable feature is the poor spatial utilization because of the requisite plate or frame thicknesses and thus the poor ratio between filtration area and the space required. Especially in cases in which the filter system can occupy only a limited amount of space, is there a problem since the relatively large-volume filtration systems can no longer be used or may be necessary but cannot effectively be applied.

In the solution described for example in EP 0 662 341 B1, in addition each individual membrane plate must be provided with a liquid evacuating device which is connected to a central liquid collector. This has a number of connection locations between the membrane plates and the filtrate collector so that the danger that leakage can arise is greatly increased. Should leakage occur, it can lead to undesired contamination of the filtrate.

It is thus an object of the present invention to provide a filtration module that can optimize the flow of liquid onto the filtration module and can ensure an improved liquid cleaning with a uniform pressure differential distribution. The filtration module should form a structural unit with a flow passage and an incident flow device [device causing flow onto the filtration module] which does not result in leakage or with which the danger of leakage is significantly reduced and which has a simple construction.

These objects are achieved by the filtration module of claim 1 which according to the invention is characterized in that the filtration membrane pockets are configured as substantially flat and flexible and which on its opposite sides is connected fixedly with the holder which has at least one suction line for leading off the liquid drawn through the filter membrane pocket opening and in that the filter membrane pockets have a flexible liquid permeable core and/or a plurality of liquid permeable core elements. The special advantage of this filtration module lies in a simplified fabrication which is associated with especially low fabrication cost, as well as in a uniform differential pressure distribution over the entire filter membrane pockets whereby, as a consequence, rigid plates or frame-forming elements can be eliminated in large measure and filter membrane damage can be eliminated as a consequence. By comparison with the approach known from the state of the art with filtration cassettes, a suction line for suction conduits are also integrated in a rigid holder so that their damage or leakage therefrom is excluded. The flexible liquid-permeable cores or core elements give rise to a defined membrane pocket interior space which remains constant.

Further features of the invention are described in the dependent claims.

Thus in the simplest case the membrane pockets are comprised of two membrane foils connected peripherally with one another, preferably by adhesive bonding, welding or also by casting with another material that preferably could form a cast holder. As a result the filter membrane pockets can easily and cost effectively be fabricated.

According to a further feature of the invention the membrane foils are comprised of a thermal setting synthetic resin [duroplastic] and/or an elastomeric synthetic resin. Preferably the thermosetting material is a phenolic resin while the elastomer is polyethylene, polyacrylo/nitrile, a polyester sulfone and/or PVC (polyvinyl chloride). Such foils have high mechanical strength.

The membranes of the prior art are susceptible to damage by sharp-edged particles contained in the liquid and for that reason to protect the nonfiltration devices of the state of the art, extensive precleaning of the liquid has been required to remove these sharp-edged particles. Through the use of the foils according to the invention, this recleaning can be eliminated and the requisite maintenance work required to avoid damage can be eliminated as well.

According to a further feature of the invention, the holder is comprised of a parallelepipedal frame which encloses the filter membrane pockets or within the interior of which the filter membrane pockets are held parallel to one another between opposite sides of that frame. Especially a holder of a synthetic resin is selected, preferably in the form of a cast thermosetting synthetic resin body whereby during the casting process a connection is made to the filter membrane pockets. The duroplastic or thermosetting material used can especially be a polyester with or without a filler or a polyurethane.

According to a further feature of the invention all of the filter membrane pockets can be provided with a common dewatering collector.

As the material for the flexible liquid permeable core, a support fleece or mat or a latticework fabric of a supporting textile, can be used. Lattice fabric materials are preferably polypropylenes, polyethylenes, glass fiber fabrics, PVC or phenolic resin fabrics. For foam-like support fleeces or mats as core materials, especially polypropylenes, polyethylenes, polyesters and PVC, as nonwoven materials, or a glass fiber mat can be employed. Alternatively or additionally, individual core elements of the flexible liquid permeable ribs can be used which preferably are affixed on the inner side of the membrane foils or are arranged on the membrane inner sides or themselves are formed from the membrane material itself. These ribs in accordance with a further embodiment of the invention can be substantially parallel to one another whereby the two opposing inner surfaces of the filter membrane have parallel ribs which run crosswise to the ribs of the opposite side. Through this feature the membrane pocket interior spaces are always of the same size even when there are nonuniform flow properties in the liquid and one of the filter membrane units is loaded to a greater extent than a neighboring filter membrane unit.

According to a further embodiment of the invention, the ribs can be connected together adhesively or via an inner support layer to reinforce the connection between them. The adhesive connection can also be formed between a liquid permeable core of a foam-like support mat and a membrane. With this feature it is possible by reversing the filtrate flow directly to back-flush the filtering membrane pockets used and achieve a better control of the layer covering the filter membranes. This also can prevent an adhesion of the membrane foils to the ribs or to a liquid permeable core and a detrimental fluttering of the membrane with time. To reinforce the adhesive or weld seam against an upward flow, the membrane pockets according to a further feature of the invention are provided with synthetic resin insert strips.

To ensure that the liquid stream will always meet the filter membrane pockets in an optimal manner, the holder which is traversed from below through an inlet passage can have a flow-generating device like a pump and/or an aeration device or at least one flow-directing baffle permanently mounted therein. This baffle can serve to distribute the cleaning flow in an optimal manner on the underside of the filtration module.

According to a further feature of the invention and to increase the functional capacity, preferably a multiplicity of holders each equipped with filter membrane pockets can be stacked one upon another.

According to a further feature of the invention the filter membrane pockets have affixed at their lower edges the cleaning fibers which extend into the interiors of the pockets. Preferably these cleaning fibers are comprised of synthetic resin and have a specific gravity which is less than the specific gravity of the liquid to be cleaned. Furthermore, the cleaning fibers preferably are elastic and/or have a diameter which is always 0.5 mm and a width which amount of 10 to 95% of the gap width of the filter membrane pocket. The mentioned fibers are moved by the liquid flow which traverses the module along the filter membrane surfaces. This constant movement of the fibers serves to ensure the improved mechanical cleaning of the filtration membranes. This has the advantage that the interval with which the module must be chemically cleaned can be increased substantially. The previous requirement for frequent removal of the module from the filtration vessel in the state of the art is thus no longer required. Furthermore, through the use of the fibers hydraulically weaker module regions which are traversed by the liquid can be cleaned more strongly mechanically to provide greater free filtration areas than otherwise would be the case. Because of the enhanced mechanical cleaning, the quantities of gas which must be introduced can be significantly reduced by comparison with embodiments without fibers. This results in a reduction of the operating cost.

Embodiments of the invention are described with respect to further details and advantages below in conjunction with the drawing. It shows

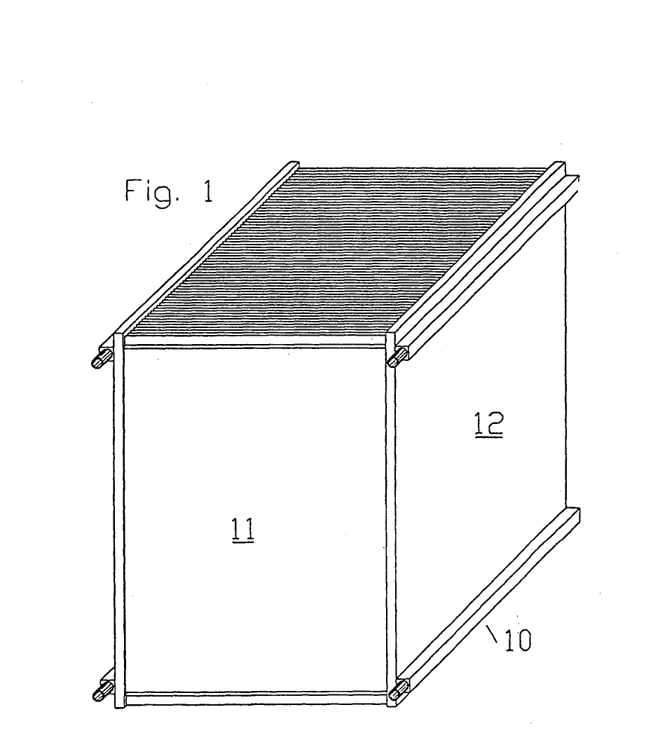

FIG. 1 a perspective view of a filtration module according to the invention,

FIG. 1a a variant of the filtration module of FIG. 1.

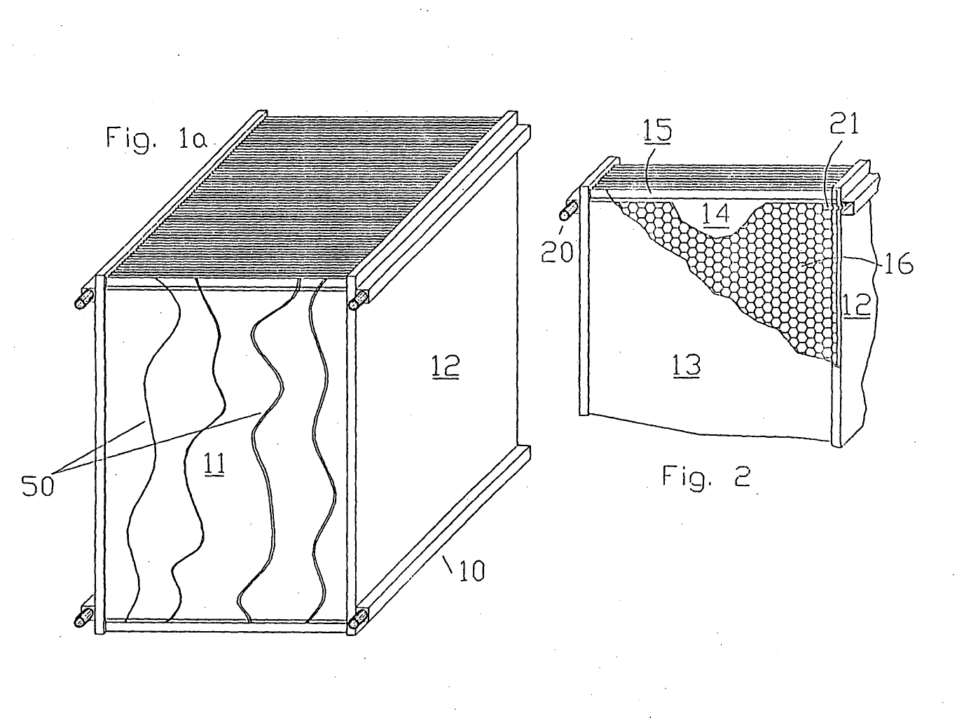

FIG. 2 a partial elevational view partly broken away of a filtration module according to claim 1 and

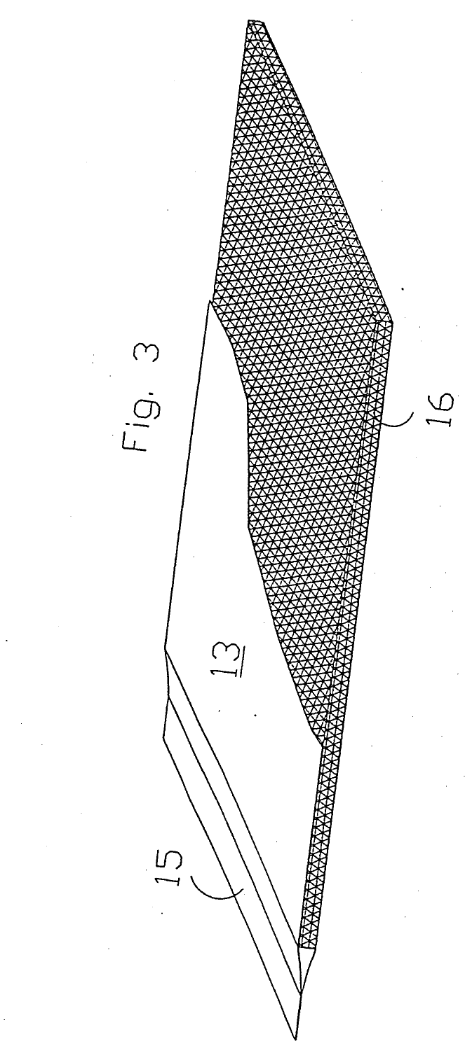

FIGS. 3 to 7 respective partial sectional views of filtration membrane pockets in different configurations.

The filtration module shown in FIG. 1 is comprised of a parallelepipedal receptacle 10 with closed side walls 11, 12. The receptacle 10 is open at its top and bottom so that liquid can flow through it. Within the receptacle and connected with this receptacle 10 are a multiplicity of flat, flexible filter pockets one alongside the other and arranged parallel to one another. The filter pockets comprise membrane foils 13 and 14 (see FIG. 2) which are closed at their upper and lower ends by means of weld seams or adhesive seams 15. Between membrane foils 13 and 14 a support fleece [mat] 16 and/or a multiplicity of flexible ribs 17, 18 or 19 are arranged. The filter membrane pockets are also closed at their respective sides which, in the drawing, extend vertically and are connected with the side wall 12 as well as with the opposite side wall. This can for example be achieved in that the lateral edges are affixed to the side wall 12 and the opposite wall by means of a casting process.

The filtration module illustrated in FIG. 1a corresponds to the previously described filtration module except that here additionally at the lower edge the filtration membrane pockets have cleaning fibers 50 affixed thereto. These cleaning fibers are comprised of elastic synthetic resin material which has a specific gravity which is smaller than the specific gravity of the waste water stream to be cleaned. The cleaning fibers can be of round, rectangular, oval or other cross section. It is important only that the cleaning fibers move back and forth as a result of the passage of the liquid through the module and thus frictionally bear upon the surfaces of the filter membrane pockets. Preferably the minimum fiber diameter or the minimum fiber width amounts to 0.5 mm. The upper limit for the fiber width is 95% of the gap width of the filter membrane pockets.

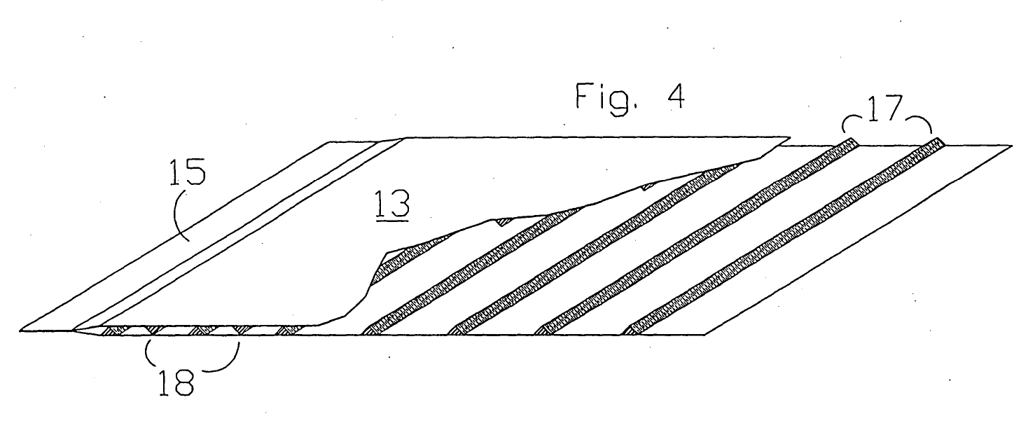

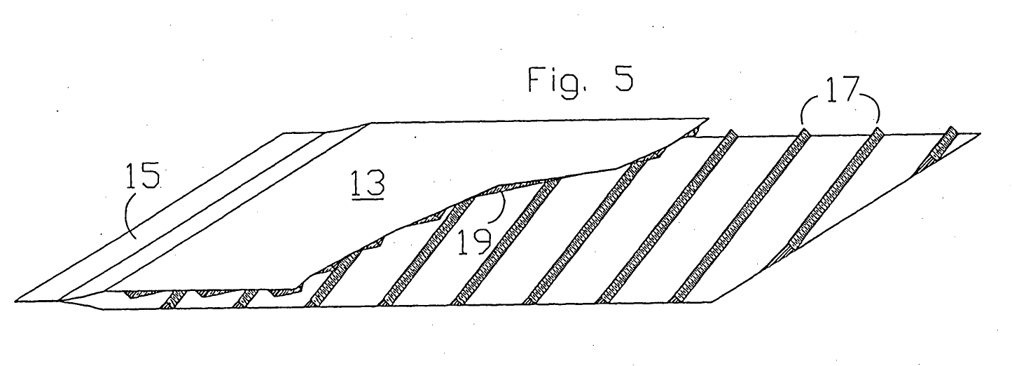

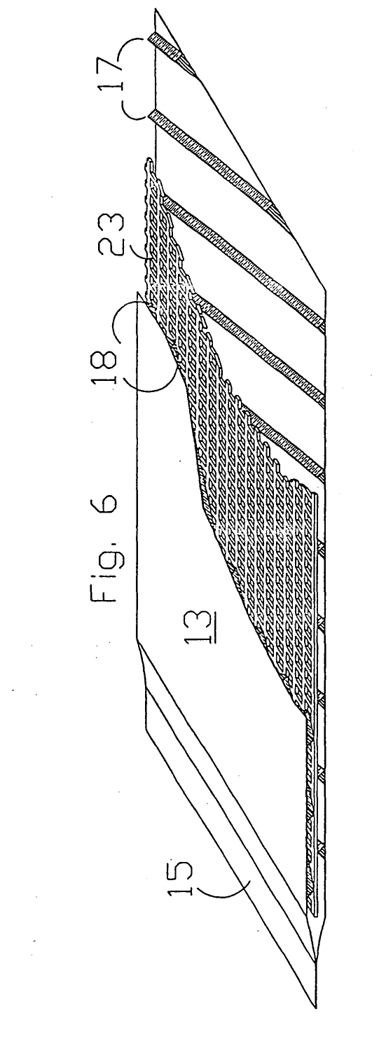

As is apparent from FIGS. 3, 4 and 5, the fleece support body or the ribs extend substantially over the entire interior height of the hollow space. The arrangement of the ribs 17 and 18 in FIG. 4 is chosen so that they lie parallel while the arrangement of the ribs 17 and 19 according to FIG. 5 is so chosen that the ribs 17 and 19 are disposed parallel to one another while the ribs 17 and 19 are disposed perpendicular [vertical] to one another. In the embodiment according to FIG. 6, a support fleece 16 is provided between the membrane foils 13 and 14 in the filter membrane pocket together with ribs 17 and 18, whereby the latter are secured to the center surfaces of the membrane foils. The ribs 17 and 18 are disposed perpendicular to one another [vertical to one another].

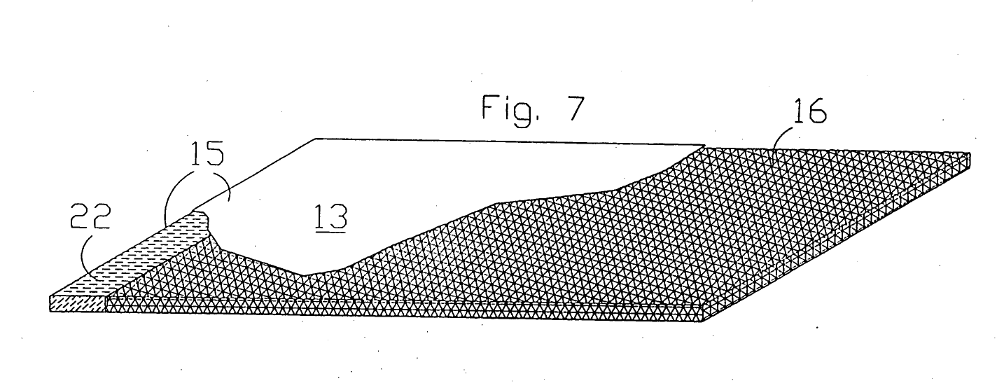

In the embodiment illustrated in FIG. 7, an adhesive or weld seams for the membrane pockets are reinforced by a strip 22 of plastic, for example of a polyester, polyurethane, ABS, polyethylene, polyphenol, or PVC. The strip 22 has the same or a similar thickness as the core material inserted into the membrane pocket and is adhesively bonded or welded on both sides with membrane parts as a result the membrane pocket can better withstand elevated flow velocities. The strip 22 also affords the possibility of further simplifying the fabrication of the membrane module since it provides a guide for the core material and by the casting process enables the individual pockets to be bonded with the pocket holder and to serve a shape stabilizing function.

From the filter membrane pockets shown in FIGS. 3 to 7 is dependent upon the size of the pockets 10. The desired number of filter membrane pocket units are disposed parallel to one another and in equispaced relationship from neighboring membrane pockets or in contact with one another with equispacing of the membrane pockets within the box 10. Each membrane pocket has a flexible liquid-permeable core or core element which is flanked on both sides by membrane foils 13 and 14. The membrane foils are cemented together or welded together with one another on two opposite sides whereby the membrane pocket thickness is reduced to the thickness of the membranes which are adhesively bonded or welded together. As a result a flow profile is obtained which gives rise to a reduction in the flow resistance and an improved flow through the filter membrane pockets. The flexible liquid permeable core and/or the core elements of the filter membrane pockets ensure that in spite of the pressure difference between the outer side of a membrane and the inner side of the membrane during the filter process, a filtrate-filled space remains between two foils 13 and 14. This space serves for the transport of filtrate from the filter. The remaining two sides of each filter pocket are connected by a casting process fixedly with the surrounding holder. The holder or the opposite walls 12 additionally have suction passages 20 for dewatering each filter membrane pocket for which purpose the filter membrane pockets have an opening 21. The advantage of this configuration is that no separate connection must be provided between the filter membrane pockets and the filtrate collector. The filter membrane pockets have an optimum filtrate-surface area/space ratio. The filtration module can thus also be used in places in which the space is limited. The mechanical resistance of the membrane foil can be ensured since robust battery separators can be used for the filtration process.

A simple filtration module construction can be achieved by initially cementing the membrane foils which are used together and then casting them in place with synthetic resin in the formation of a pocket holder. The unit constituted of the membrane pockets and the pocket holder forms the filtration module. In a finishing step a number of filtration membrane pockets can be assembled to a module in this manner.

The holder forms the outer enclosure of the filtration module so that an additional separate membrane receiving box can be omitted. The holder 10 is connected fixedly with an inlet duct (not shown) which can be arranged below the pocket holder. In this inflow passage, as is the case basically also in the state of the art, for example from EP 0 662 341 B1, a flow generating device like an aeration device or a pump can be included. The result is a complete free-standing functional unit which can be integrated into a liquid-filled work tank in the form of a box 10. An expensive provision of modules for coupling upper and lower boxes together can be avoided.

Basically a multiplicity of filtration modules 10 can be directly provided in such manner as to provide an improved utilization of unitary flow.

The battery separator foils which are used for filtration have on their inner sides, ribs 10, 18, 19 which serve as spacers to hold open the filtrate spaces. The ribs are either cemented together to achieve a greater stiffness of the filter pockets or are connected together via a support mat in the form of a support fleece.

1. A filtration module for the cleaning of waste water with a multiplicity of filtration membrane pockets each having at least one opening (21) for the dewatering of its interior space and which are disposed vertically, parallel to one another and preferably at the same spacing to one another in a rigid holder and so arranged that the intervening spaces lying between neighboring filter membrane pockets are intensively traversed by a liquid, characterized in that the filter membrane pockets are configured to be substantially flat and flexible and on opposite sides (12) are fixedly connected with the holder which has at least one suction line (20) for carrying off liquid drawn out through the filter membrane pocket opening (21), and in that the filter membrane pockets have a flexible liquid permeable core (16) and/or a plurality of flexible permeable core elements (17, 18, 19).

2. The filtration module according to claim 1, characterized in that the filter membrane pockets are comprised of two peripherally interconnected membrane foils (13, 14) which preferably are connected together by adhesive bonding, welding or by casting with another material that further preferably can form the cast holder.

3. The filtration module according to claim 1, characterized in that the membrane foils (13, 14) are composed of a thermosetting and/or elastomeric synthetic resin, preferably from a thermosetting phenolic resin, polyethylene, polyacrylonitrile, polyethersulfone and/or polyvinylchloride (PVC).

4. The filtration module according to claim 1, characterized in that the holder, a rectangular parallelepipedal frame (10) into which the membrane filter pockets are laterally incorporated.

5. The filtration module according to claim 1, characterized in that the holder (10) is comprised of plastic, preferably of a cast thermosetting synthetic resin body, especially of polyester with or without a filler or from polyurethane.

6. The filtration module according to claim 1, characterized by a common dewatering collector for all of the filter membrane parts.

7. The filtration module according to claim 1, characterized in that the flexible liquid permeable core is a foam-like support fleece (16) which is comprised preferably of polypropylene, polyethylene, polyester, glass fiber textiles or PVC, or is a support textile which preferably is composed of polypropylene, polyethylene, glass fiber fabric, PVC or a phenolic resin fabric.

8. The filtration module according to claim 1, characterized in that individual core elements (17, 18, 19) are flexible ribs which preferably are fastened at the membrane foil inner sides or are arranged on the membrane foil inner side and are comprised of membrane parts themselves.

9. The filtration module according to claim 8, characterized in that the ribs (17, 18, 19) are arranged substantially parallel to one another and/or that the opposing filter membrane inner surfaces respectively have parallel ribs (17 or 18) which are arranged crosswise to the ribs of the opposite sides.

10. The filtration module according to claim 8, characterized in that the core elements (17, 18, 19) are adhesively bonded to each other and/or with the membrane foils (13, 14).

11. The filtration module according to claim 7, characterized in that either the foam-like support fleece (16) or the support fleece (16) with additional core elements (17, 18, 19) are adhesively bonded with the membrane foil (13, 14).

12. The filtration module according to claim 1, characterized in that the filter membrane pockets have a synthetic resin insert strip for reinforcing the adhesive or weld seam with respect to rising flow.

13. The filtration module according to claim 1, characterized in that the holder (10) is connected with an inlet passage at its lower side in which a flow generating device like a pump and/or an aerator and/or in which at least one flow-directing baffle body is arranged.

14. The filtration module according to claim 1, characterized in that a multiplicity of holders (10) each equipped with filter membrane pockets are disposed one above another.

15. The filtration module according to claim 1, characterized in that the filter membrane pockets have cleaning fibers fixed at their lower edges and which extend within the inner space of each pocket.

16. The filtration module according to claim 15, characterized in that the cleaning fibers are comprised of synthetic resin, preferably having a specific gravity which lies within the specific gravity of the waste water to be cleaned and/or in that the cleaning fibers are elastic and/or in that the cleaning fibers have a fiber diameter which lies between 0.5 mm and a width which is 10 to 95% of the gap width of the filter pocket.
